(19) United States
(12) Patent Application Publication
(10) Pub. No.: US 2016/0035152 A1
(43) Pub. Date: Feb. 4, 2016

(54) VEHICLE DATA MINING BASED ON VEHICLE ONBOARD ANALYSIS AND CLOUD-BASED DISTRIBUTED DATA STREAM MINING ALGORITHM

(71) Applicant: Hillol Kargupta, Ellicott City, MD (US)

(72) Inventor: Hillol Kargupta, Ellicott City, MD (US)

(73) Assignee: AGNIK, LLC, Columbia, MD (US)

(21) Appl. No.: 14/586,952

(22) Filed: Dec. 30, 2014

Related U.S. Application Data
(60) Provisional application No. 61/922,092, filed on Dec. 31, 2013.

(51) Int. Cl. G07C 5/00; G06F 17/30; G07C 5/08

(52) U.S. Cl. CPC G07C 5/008; G07C 5/0808; G06F 17/30539; G06F 17/30876

(57) ABSTRACT

The present invention relates to a system and method for performing vehicle onboard analysis on the data associated with the vehicle and implementing a cloud-based distributed data stream mining algorithm for detecting patterns from vehicle diagnostic and correlating the pattern with the contextual data. The system applies the distributed data mining algorithms for mining the results of the vehicle onboard analytics sent over the wireless network to the server and correlates the analyzed data with the contextual data of the vehicle. The system extracts performance patterns from data, builds predictive models from vehicle diagnostic, and correlates the predicted model with the business process using state of the art link analysis techniques.

This application claims the benefit of U.S. Provisional Application No. 61/922,092, filed Dec. 31, 2013, which is hereby incorporated by reference in its entirety.

### FIELD OF THE INVENTION

The present invention relates to vehicle data mining and more particularly relates to performing vehicle onboard analysis and implementing a cloud-based distributed data stream mining algorithm for performing data analytics for extracting business intelligence from the collected data of a vehicle.

### BACKGROUND OF INVENTION

Currently, there are many ways of recording vehicle telematics data and performing data analytics on the recorded data such as monitoring or determining the vehicle movement and analyzing the performance or other associated parameters by collecting the vehicle data using on-board devices such as sensors or recorders. The collected data is analyzed by using various onboard and remote data stream mining algorithms. As the number of the vehicles used for commercial purpose increases, the number of telematics data required for monitoring vehicles also have increased proportionally. Hence, the data stream mining algorithms must be capable of handling various factors associated with the vehicle monitoring, determining performance of the vehicle, or to extract business intelligence based on the data analysis. The existing data stream mining algorithm used for implementing the vehicle data mining or data analysis onboard or remotely is not readily scalable as the data stream mining algorithm is dependent on the availability of the network resources. Due to the algorithm's dependency on the available network resource, the existing on-board and remote data stream mining algorithm imposes a limitation on the performance factor while implementing the data mining or data analysis task on the vehicle data.

Further, in some of the existing onboard vehicle data mining systems, the vehicle data is collected from onboard devices such as portable electronic devices that include Laptops, smart phone, mobile communication devices or the like. The collected data in onboard device is further analyzed onboard or remotely by using the data stream mining and management capabilities to determine the driver's performance or to monitor the vehicle's performance. Some of the advanced data stream mining algorithms that can be used on board includes but not limited to principal component analysis, clustering, anomaly detection, predictive modeling, classification using support vector machines, decision trees for analysis of the vehicle performance data onboard the vehicle. Application of the onboard vehicle performance data mining technology includes but not limited to advanced fuel consumption modeling, emissions monitoring and smog test, driver behavior scoring, and vehicle health scoring. Application of the vehicle performance data mining technology in a distributed environment comprises of multiple vehicles connected over wireless networks for insurance premium computation, vehicle-to-vehicle social networking, playing computer games, and adaptive placement of advertisement based on vehicle performance profile.

As discussed above, the existing onboard data stream mining and management algorithm is implemented in a distributed or a non-distributed environment. Since, cloud-based environment is becoming popular in today's scenario owing to the factors such as scalability, cost-effectiveness and security, the existing onboard data stream mining and management algorithm system can be augmented with a cloud-based distributed environment for implementing a scalable, secured, accurate data mining and management system.

Hence, there is a need for a high performance vehicle data stream mining and management system implemented in a scalable, cost-effective, and secure cloud-based environment. U.S. Pat. No. 8,478,514 is directed to methods and systems using mobile and distributed data stream mining algorithms for mining the continuously generated data from different components of a vehicle. The system is designed for both on-board and remote mining and management of the data in order to detect the effect of various engine parameters such as fuel consumption behavior, predictive classification of driving patterns and associative indexing of driver performance matrix, resource-constrained anomaly detection for onboard health monitoring, vehicle-to-vehicle social networking and distributed data mining, adaptive placement of advertisements based on vehicle performance profile and onboard emissions analytics computation for wireless emissions monitoring and smog test.

U.S. Pat. No. 7,715,961 is directed to method and system using onboard data stream mining techniques for extracting data patterns from the data that is continuously generated by different components of a vehicle. The system stores the data patterns in an onboard micro database and discards the data. The system uses a resource-constrained, small, lightweight onboard data stream management processor, with onboard data stream mining, an onboard micro database, and a privacy-preserving communication module, which periodically and upon request communicates stored data patterns to a remote control center. The control center uses the data patterns to characterize the typical and unusual vehicle health, driving and fleet behavior.

U.S. Pat. No. 8,095,261 is directed to finding when a fault condition has occurred for a vehicle component, system or sub-system by using data mining techniques from varieties of data stored in a database that are gathered from similar vehicles' components, system, or sub-systems.

US Publication No. U.S. Pat. No. 7,082,359B2 to David S. Breed., describes about Information management for a vehicle including a vehicle monitoring system with a plurality of sensors for monitoring vehicular components, a diagnostic module arranged on the vehicle and coupled to the vehicle monitoring system to receive and process data about the components therefrom, and a remote service center capable of servicing the components.

US Publication No. US20050065678A1 to Andrew Smith., describes about an enterprise-resource planning system in which information processing and data management systems may be integrated with vehicle diagnostic and information systems.

US Publication No. US20050060070A1 to Michael Kapolka., describes about a system for remote vehicle diagnostics, telematics, monitoring, configuring, and reprogramming.

US Publication No. US20050065678, to Kirk Corey., relates to an enterprise resource planning (ERP) system in which information processing and data management are integrated with vehicle diagnostics.

US Publication No. U.S. Pat. No. 6,609,051, to Achim Bertsche, describes about Monitoring the state of a motor vehicle using machine learning and data mining technology to generate component models that are then used to monitor components, predict failure, and so on.

### SUMMARY OF THE INVENTION

The present invention is related to a system and method for performing vehicle onboard analysis of the data associated with the vehicle telematics and implementing a cloud-based distributed data stream mining algorithm onboard for performing vehicle data mining on the collected data of a vehicle within a wireless network, wherein the method comprises of receiving the results of the onboard analysis of data at a server within the wireless network. Further, the method executes the cloud-based distributed data stream mining algorithm at the server on the received data from onboard analysis. The method executes the cloud-based distributed data stream mining algorithm on the received data from onboard analysis by dividing the onboard analysis data into subsets of data. The subsets of data are stored on a set of nodes within the wireless network. Further, the method divides a set of tasks in to sub-tasks for performing data analysis on the subset of data stored on the set of nodes. Further, the method combines the results after performing data analysis on the subset of data and displays the combined data analysis results performed on the collected data of the vehicle on a web interface that is connected to the server.

### BRIEF DESCRIPTION OF THE DRAWINGS

FIG. 1, according to an embodiment of the present invention, depicts an overview of the system for performing vehicle onboard analysis on the vehicle data and implementing a cloud-based distributed data mining algorithm for performing data analytics on the vehicle collected data.

FIGS. 2a and 2b, according to an embodiment of the present invention, is a system overview of the components required to perform onboard data analysis on the vehicle data and implementing the cloud-based data mining algorithm for detecting data pattern and correlating the data pattern with the vehicle collected data.

FIG. 3, according to an embodiment of the present invention, is an overview of components required to implement the cloud-based distributed data stream mining algorithm in a cloud computing infrastructure.

FIGS. 4, 5, 6, 7, 8, and 9, according to an embodiment of the present invention, depicts various business intelligence reports extracted after performing data analysis on the vehicle collected data.

### FIGURES—REFERENCE NUMERALS

100—System overview for performing onboard data analysis and implementing a cloud-based distributed data stream mining algorithm in a cloud computing infrastructure
101—Onboard Data Mining module used for performing onboard vehicle data analysis
102—Wireless Communication module for establishing a wireless communication network within the system
103—Cloud Computing Infrastructure
104—Distributed data mining nodes and storage in the cloud environment
200—System overview of components required for performing onboard data analysis and implementing the cloud-based distributed data stream mining algorithm
201—Data Source module used to collect telematics and/or contextual data of the vehicle
202—Data Mining module used for mining the vehicle telematics and contextual data
202a—Onboard data mining module used for onboard vehicle data mining
202b—Cloud-based distributed data mining module for implementing the cloud-based distributed data stream mining algorithm
203—Data Pattern Visualization module used for presenting the data pattern on a web-browser-based interface
204—Controlling module used for performing additional functionalities within the system

### DETAILED DESCRIPTION OF THE PREFERRED EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The term “vehicle collected data” refers to the telematics data and the contextual data associated with the vehicle. In an embodiment, the telematics data refers to the onboard data of the vehicle collected from various sources such as vehicle data bus, location data, accelerometer data from the onboard devices and mobile phones, user experience data, gyroscope sensor data, magnetic sensor data, compass data from onboard devices and mobile phones, sound sensor data from onboard devices and mobile phones. Onboard devices can be Engine Control Unit (ECU), Telematics Control Unit (TCU) or light-duty or heavy-duty dongles that plug into the vehicles' OBDII/J1708/J1939 data ports. In an embodiment, the contextual data includes financial information for the vehicle and historical records of the vehicle owner, vehicle's previous ownership data, weather data, road condition data or the like that is associated with the vehicle.

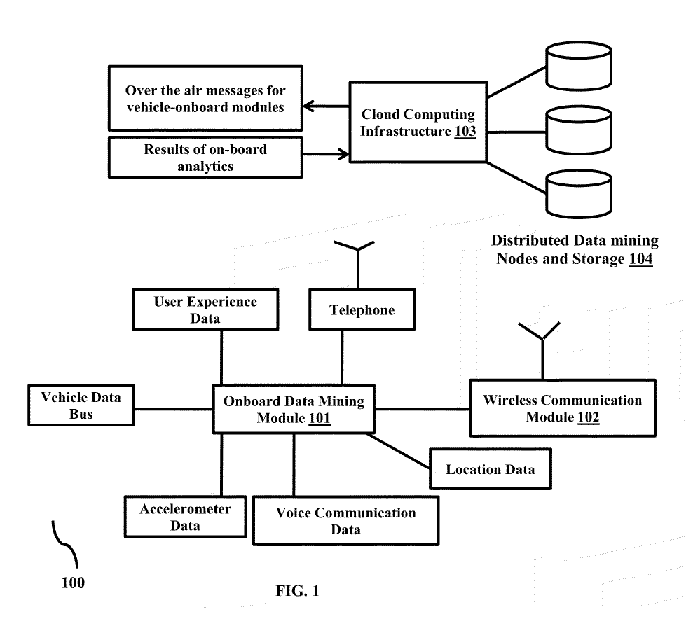

FIG. 1 depicts an overview of the system 100 for performing vehicle onboard analysis on the vehicle data and implementing a cloud-based distributed data stream mining algorithm for performing data analytics on the vehicle collected data. In an embodiment, the Onboard Data Mining module 101 is configured to receive the vehicle performance data from various sources such as:
a. Vehicle data bus: provides various vehicle performance data such as diagnostic information, emissions data, fuel consumption data and driver behavior data.
b. Location data: location information using global positioning system (GPS) technology and assisted GPS technology using the GPS chip inside the onboard devices or the mobile phones based on various land-based location management techniques.
c. Accelerometer data: provides three-axes accelerometer data providing vehicle acceleration and deceleration information along three axes.
d. User experience data: provides various types of user behavior data such as radio channel usage, mobile phone gyroscope data, mobile phone magnetic sensor data, mobile phone compass data, interaction with different in-vehicle switches and control mechanisms.

In an embodiment, after receiving the vehicle data from various data sources, the Onboard Data Mining module 101 analyzes the collected data inside the onboard devices.

In an embodiment, an Onboard Data Mining module 101 is configured to select features, extract features, and construct features from the spatio-temporal data that is collected from the vehicle and is configured to analyze and model data in conjunction with the contextual data, onboard the vehicle, whenever required. In an embodiment, the onboard data mining module 101 is configured to send the collected data and the results of the onboard analysis to a Wireless communication module 102. Further, the Wireless communication module 102 is configured to send the results of the onboard analysis to the cloud computing infrastructure 103 over the wireless network. The Onboard Data Mining module 101 is configured to interact with the Wireless Communication Module 102 that comprises of a cellular or satellite wireless modem for transferring the collected data onboard the vehicle or the results of the onboard analysis to the remote computers over the wireless network. In an embodiment, the Onboard Data Mining module 101 is configured to collect data from a Telephone within the wireless network, wherein the telephone of the driver is used for communicating directly with the in-vehicle computing platform over a local area wireless network or with remote computers over wide-area wireless networks. Further, the analyzed data is sent to the cloud computing infrastructure 103 for further processing of the analyzed data. In an embodiment, the cloud computing infrastructure 103 is configured to receive the results of the onboard analyzed data available at a server within the wireless network and the cloud-based distributed data stream mining algorithm is executed on the onboard analysis data for performing further analysis on the analyzed data.

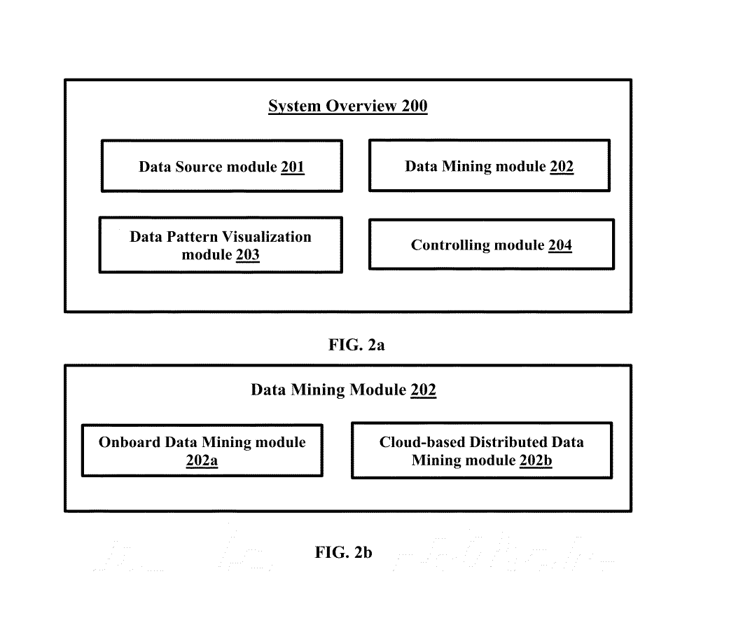

Referring to FIGS. 2a and 2b, depicts a system overview 200 of the components required to perform onboard data analysis on the vehicle data and implementing the cloud-based data mining algorithm for detecting data pattern and correlating the data pattern with the vehicle collected data. In an embodiment, a Data Source module 201 is configured to receive vehicle telematics data from various sources such as vehicle data bus, location data, accelerometer data, and user experience data along with contextual data associated with the vehicle. In an embodiment, a Data Mining module 202 is configured to perform onboard data analysis using an Onboard Data Mining module 202a and/or a cloud-based data analysis using a Cloud-based Distributed Data Mining module 202b. In an embodiment, a Data Pattern Visualization module 203 is configured to present the analyzed data patterns on a web-browser based interface. For example, the data pattern presented by the Data Pattern Visualization module 203 can depict the following on a web-browser based interface:
A vehicle health problem trend analysis to visualize how different vehicle health problems occur at different times in the lifetime of a vehicle and the distribution of these time-dependent vehicle-health-events patterns and statistical properties of the distribution.
A fault code distribution to visualize the frequency distribution of vehicle diagnostic fault codes.
A fault code correlation to visualize the statistical correlation between vehicle diagnostic fault codes. The correlation is computed based on the time series data about the vehicle diagnostic fault codes from different vehicles.
Clustering of vehicle health distribution to visualize the clusters generated using the vehicle diagnostic data.
Expected repairs to visualize the list of expected repairs for a vehicle and the associated confidence.
Expected repairs to visualize the frequency of same type of repairs for different vehicle makes and models.
Vehicle performance benchmark to visualize the performance score of the benchmarked vehicles with respect to the benchmark vehicle.
Fault dependency plot to visualize the statistical dependencies among different vehicle diagnostic fault-codes. It shows how different types of vehicle health problems can generate other types of vehicle health problems.
A gear change behavior to visualize the statistical joint distribution of the gear change events along with the corresponding engine rpm and velocity.
Landmark-based statistics to visualize properties of distribution of vehicles that pass by near a given location. It shows the types of vehicles that pass by a given location over a period of time and the statistics about the vehicles performance.
Driver behavior statistics to visualize the spatial and temporal properties of the driver behavior, including how drivers behave at a given location or a given type of location at a certain time of the day or week.

In an embodiment, a Controlling module 204 is configured to perform additional activities while implementing a cloud-based data mining algorithm, such as transferring collected data across various modules within the system, displaying the analyzed data to the user on the web-browser interface, receiving the onboard analyzed data at the server, dividing the analyzed data across a set of nodes within the wireless network or the like. In an embodiment, the Onboard Data Mining module 202a is configured to send the collected data and results of the onboard analysis data to the wireless communication module 102. Further, the wireless communication module 102 is configured to send the collected data and the onboard analyzed data to the cloud computing infrastructure 103 over the wireless network. In an embodiment, the Cloud-based Distributed Data Mining module 202b is configured to perform distributed data analysis in the Cloud Computing Infrastructure 103 after receiving the onboard analysis data from the vehicle Onboard Data Mining module 202a. In an embodiment, the Cloud-based Distributed Data Mining module 202b is configured to perform data analysis to extract the data patterns by using one or more detection algorithms such as: distributed trend analysis of performance data from vehicle sub-systems over time, distributed multivariate modeling of diagnostic data, distributed detection of frequent patterns of failures, distributed comparative analysis of vehicles of same makes and models, comparative analysis of vehicles of different makes and models, benchmarking, predictive failures and detection of varieties of geo-spatial patterns from location data. The Cloud-based Distributed Data Mining module 202b is configured to execute the cloud-based data mining algorithm on the onboard analysis data by performing the following steps:
1) Dividing or decomposing the onboard analysis data into a subset of data that is stored on a set of nodes within the wireless network.
2) Dividing a set of tasks in to sub-tasks for performing data analysis on the subset of data stored on the set of nodes.
3) Combining the results after performing data analysis on the subset of data and
4) Displaying the combined data analysis results performed on the telematics and/or contextual data of the vehicle.

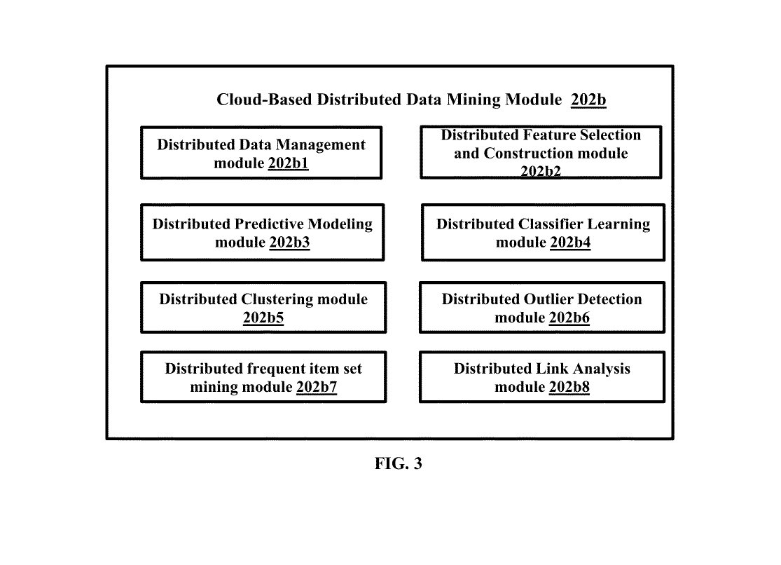

Referring to FIG. 3, depicts an overview of components required to implement the cloud-based data mining algorithm in the cloud computing infrastructure 103. The Cloud computing infrastructure 103 comprises of a Cloud-based Distributed Data Mining module 202b. The Cloud-based Distributed Data Mining module 202b further comprises of the following modules: a Distributed Data Management module 202b1, a Distributed Feature Selection and Construction module 202b2, a Distributed Predictive Modeling module 202b3, a Distributed Classifier Learning module 202b4, a Distributed Clustering module 202b5, a Distributed Outlier Detection module 202b6, a Distributed frequent item set mining module 202b7, and a Distributed Link Analysis module 202b8. In an embodiment, the Distributed data management module 202b1 is configured to store and manage data in a distributed environment using distributed file system and indexing techniques. In an embodiment, the Distributed feature selection and construction module 202b2 is configured to select features and construct new features from existing features using the distributed algorithms. In an embodiment, the Distributed predictive modeling module 202b3 is configured to predict failures using distributed predictive algorithms for parametric and non-parametric modeling in order. In an embodiment, the Distributed classifier learning module 202b4 is configured to use distributed algorithms for learning linear and non-linear classifiers. In an embodiment, the Distributed clustering module 202b5 is configured to use distributed algorithm for clustering the received data. In an embodiment, the Distributed outlier detection module 202b6 is configured to use distributed algorithm in outlier detection of data pattern. In an embodiment, the Distributed frequent itemset mining module 202b7 is configured to use distributed algorithm for computing frequent item sets. In an embodiment, the Distributed link analysis module 202b8 is configured to use distributed algorithm for performing link analysis using graph theoretic and other techniques. In an embodiment, the distributed algorithm used by the Cloud-based Distributed Data Mining module 202b can be categorized as:

A Map-reduce-based algorithm for decomposing the tasks among a set of smaller tasks, computing those tasks at different nodes in the cloud-based environment, and combining the results in order to produce the final results.

An Ensemble-based algorithm for performing the following activities: dividing the data among different nodes, performing the modeling at different nodes using the distributed data, and combining the models using the ensemble-based techniques.

A Peer-to-peer asynchronous algorithm that works using local computation technique. The algorithm work through asynchronous peer-to-peer communication among the nodes.

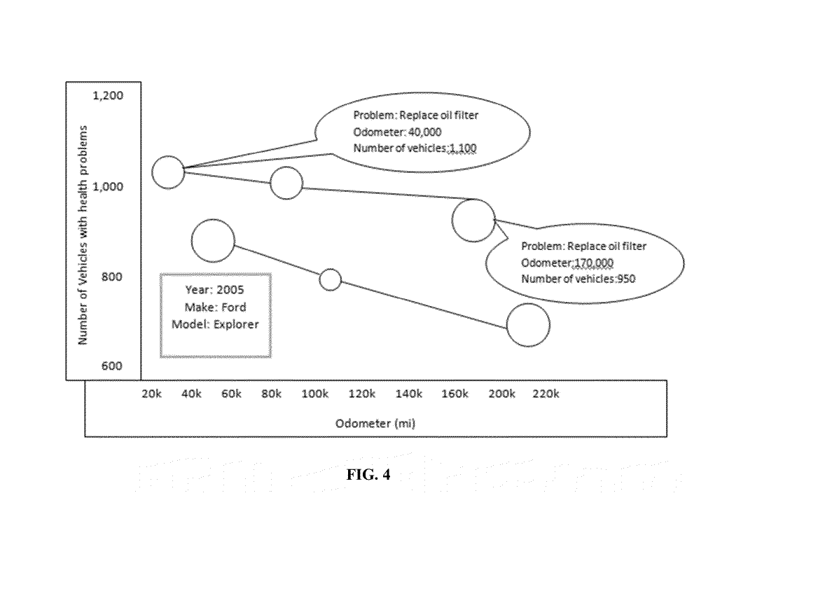

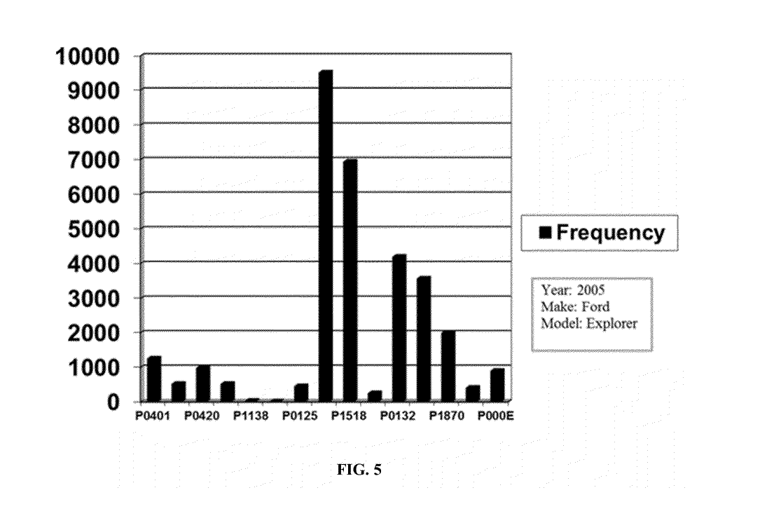

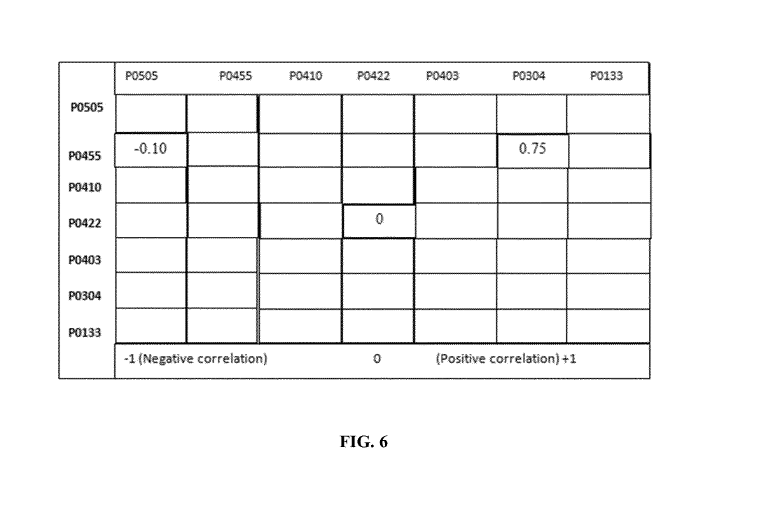

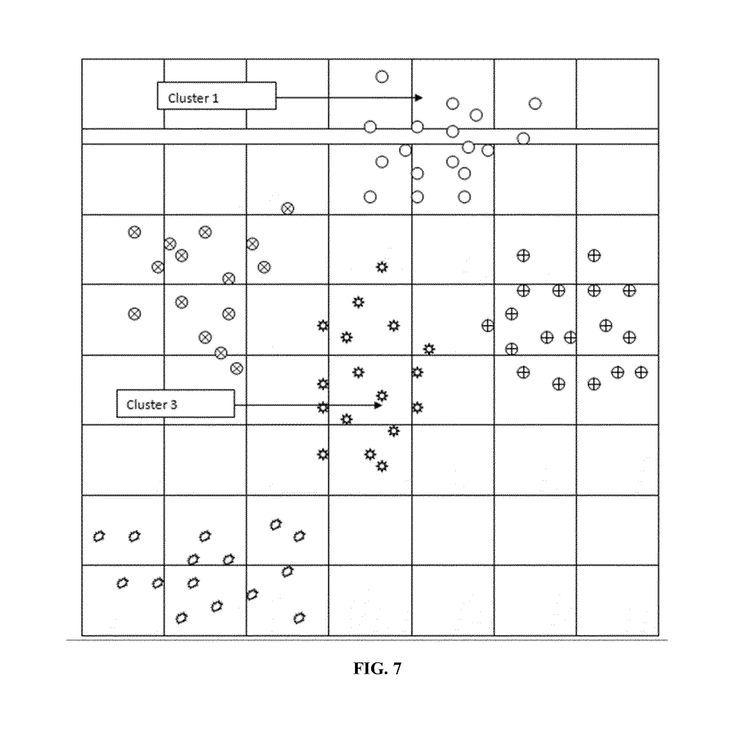

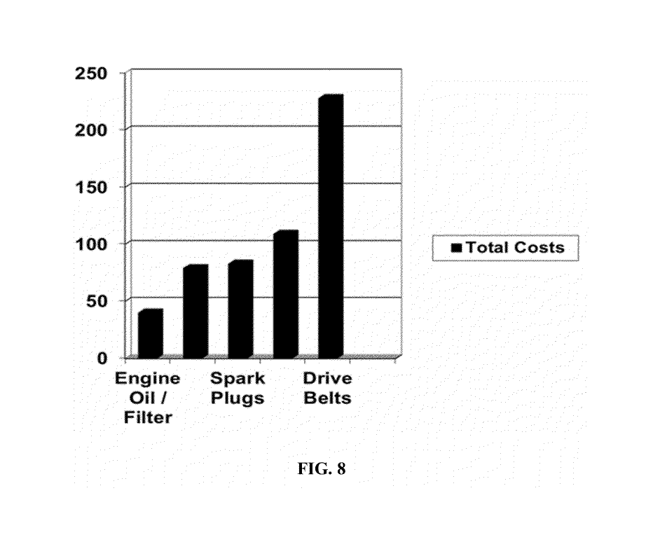

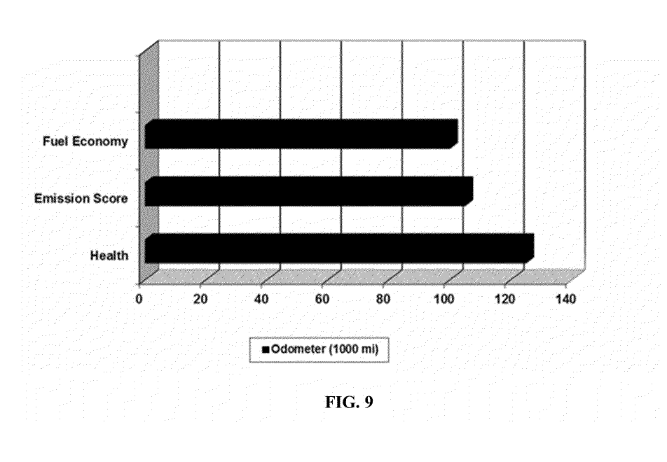

Referring to FIGS. 4, 5, 6, 7, 8, and 9 depicts various business intelligence reports extracted after performing data analysis on the vehicle collected data. FIG. 4, depicts a graphical representation of health problems encountered for a particular model of the vehicle within a specific period of time. FIG. 5, depicts a graphical representation of frequency of the chassis failure encountered for a particular model of the vehicle within a specific period of time. FIG. 6, depicts a graphical representation of correlation analysis result associated with the vehicle telematics data. FIG. 7, depicts a graphical representation of clustering points determined after performing data analysis on the vehicle telematics data. For example, cluster 1 depicts distribution of chassis failure encountered for a particular model of the vehicle within a specific geography location. Cluster 3 depicts number of vehicle problems encountered within a specific geography location associated with a particular model of the vehicle.

Although the embodiments herein are described with various specific embodiments, it will be obvious for a person skilled in the art to practice the invention with modifications. However, all such modifications are deemed to be within the scope of the claims.

1. A system for performing vehicle onboard analysis on the data associated with the vehicle and implementing a cloud-based distributed data mining algorithm on the onboard analyzed data for detecting patterns from vehicle diagnostic and correlating the pattern with the contextual data, wherein the system comprises of an Onboard Data Mining module and a Cloud-based Distributed Data Mining module and is configured to:
a) receive the onboard analyzed data at a server within said wireless network after performing the vehicle onboard analysis on the data associated with the vehicle;
b) collect additional contextual data associated with the vehicle from at least one data source;
c) execute said cloud-based distributed data stream mining algorithm on the received onboard analyzed data; and
d) display the combined data analyzed result determined for said vehicle collected data.

2. The system as claimed in claim 1, wherein the collected data comprises of the telematics data and/or contextual data associated with the vehicle.

3. The system as claimed in claim 1, wherein executing said cloud-based data stream mining algorithm on the received onboard analysis data comprises of:
a) dividing said onboard analysis data into a subset of data that is stored on a set of nodes within said wireless network;
b) dividing a set of tasks into sub-tasks for performing data analysis on the subset of data stored on the set of nodes; and
c) combining the results after performing data analysis on the subset of data.

4. The system as claimed in claim 3, wherein dividing said onboard analysis data into said subset of data is implemented using an Ensemble-based algorithm.

5. The system as claimed in claim 3, wherein dividing a set of tasks into said sub-tasks is implemented using a Map-reduce-based algorithm.

6. The system as claimed in claim 3, wherein communication across the set of nodes within the network is established using a peer-to-peer asynchronous algorithm.

7. A computer program product comprising computer executable program code recorded on a computer readable non-transitory storage medium, said computer executable program code when executed, causing the actions including:
a) receiving the results of the onboard analysis data at a server within said wireless network;
b) collecting additional contextual data associated with the vehicle from at least one data source;
c) executing said cloud-based distributed data stream mining algorithm on the received onboard analysis data; and
d) displaying the combined data analysis result determined for said vehicle collected data.
e) extracting at least one data pattern by applying distributed computing on said combined data analysis result.

8. The computer program product as claimed in claim 7, wherein said at least one data pattern extracted from said combined data analysis result comprises of:
a) displaying frequency distribution of different diagnostics trouble codes for a particular year, make, and model.
b) displaying correlation of different diagnostics trouble codes occurring at the same time for said vehicle.
c) displaying frequency of same diagnostic trouble codes from different vehicles of different makes of vehicles.
f) displaying frequency of same diagnostic trouble codes from vehicles of same make but different models.
g) displaying expected repair jobs needed for said vehicle year, make, and model at different miles.
h) displaying percentage of vehicles considered to be under performing, performing, and performing well compared to the performance of a benchmark vehicle.
i) displaying cumulative maintenance costs for said vehicle and displaying cumulative maintenance costs per mile (CPM) for said vehicle.
j) analyzing vehicle performance data onboard and multitude of server nodes and displaying driver rating for one or a set of drivers.
k) finding vehicle risks based on insurance losses in various categories and displaying the results of the findings.

9. The computer program product as claimed in claim 7, wherein executing said cloud-based data mining algorithm on the received onboard analysis data comprises of:
a) dividing said onboard analysis data into a subset of data that is stored on a set of nodes within said wireless network;
b) dividing a set of tasks in to sub-tasks for performing data analysis on the subset of data stored on the set of nodes; and
c) combining the results after performing data analysis on the subset of data.

10. The computer program product as claimed in claim 9, wherein dividing said onboard analysis data into said subset of data is implemented using an Ensemble-based algorithm.

11. The computer program product as claimed in claim 9, wherein dividing a set of tasks into said sub-tasks is implemented using a Map-reduce-based algorithm.

12. The computer program product as claimed in claim 9, wherein communication across the set of nodes within the network is established using a peer-to-peer asynchronous algorithm.
